(19) United States
(12) Patent Application Publication
(10) Pub. No.: US 2026/0183644 A1
(43) Pub. Date: Jul. 2, 2026

(54) Method and Apparatus for Controlling Electric Skateboard, and Electric Skateboard

(71) Applicant: ZHEJIANG GAUGEWILL ELECTRONICS COMPANY, LTD, Quzhou, Zhejiang (CN)

(72) Inventors: Dongfang LONG, Quzhou, Zhejiang (CN); Yangyong WANG, Quzhou, Zhejiang (CN)

(73) Assignee: ZHEJIANG GAUGEWILL ELECTRONICS COMPANY, LTD, Quzhou, Zhejiang (CN)

(21) Appl. No.: 18/858,447

(22) PCT Filed: May 24, 2022
(86) PCT No.: PCT/CN2022/094764

§ 371 Date: Oct. 21, 2024

(30) Foreign Application Priority Data
Apr. 21, 2022 (CN) 202210422384.0

(51) Int. Cl. A63C 17/12; A63C 17/26

(52) U.S. Cl. CPC A63C 17/12; A63C 17/26

(57) ABSTRACT

Provided are a method and apparatus for controlling an electric skateboard, and an electric skateboard. The method includes: firstly, pressure data of two strain sensors are acquired in real time, and the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard; then, an absolute value of a difference between the first pressure data and the second pressure data is calculated to obtain a first difference; and finally, an electric motor is controlled to rotate in a predetermined direction at a predetermined speed at least according to the first difference, so that the electric skateboard advances or retreats.

### CROSS-REFERENCE TO RELATED APPLICATION

This application is a U.S. National Phase application of International Application No PCT/CN2022/094764 filed on May 24, 2022, which claims the benefit of the priority of a Chinese patent application submitted to the Patent Office of the People's Republic of China on Apr. 21, 2022, with application No. 202210422384.0, which is incorporated in its entirety herein by reference.

### TECHNICAL FIELD

The disclosure relates to the field of skateboards, and in particular to a method and apparatus for controlling an electric skateboard, a non-transitory computer-readable storage medium, a processor, and an electric skateboard.

### BACKGROUND

A conventional electric skateboard is accelerated or decelerated primarily by controlling an electric motor through a handheld wireless handle. In consequence, it can hardly realize complete “somatosensation” control and a control method is complex because a user has to control an advance direction, a retreating direction, acceleration, and deceleration with the aid of the handle.

Therefore, it is a pressing issue to provide a method for implementing all actions of the skateboard after a user leans to the left, right, front, or back.

The above information disclosed in the background art is only for enhancement of understanding of the background art of the technology described herein. In consequence, the background art may involve some information that has not constituted the prior art known in China to those skilled in the art.

### SUMMARY

The disclosure provides a method and apparatus for controlling an electric skateboard, a non-transitory computer-readable storage medium, a processor, and an electric skateboard.

In an aspect, a method for controlling an electric skateboard is provided according to an example of the disclosure. The electric skateboard includes an electric motor and two strain sensors, and the two strain sensors are arranged at two ends of the electric skateboard respectively; and the method includes: pressure data of the two strain sensors are acquired in real time, and the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard; an absolute value of a difference between the first pressure data and the second pressure data is calculated to obtain a first difference; and the electric motor is controlled to rotate in a predetermined direction at a predetermined speed at least according to the first difference, so that the electric skateboard advances or retreats, and the predetermined direction indicates forward rotation or reverse rotation.

Optionally, before the pressure data of the two strain sensors are acquired in real time, the method further includes: initial pressure data of the two strain sensors are acquired, and the initial pressure data are the pressure data generated when the target object stands on the electric skateboard with two feet, and the initial pressure data include first initial pressure data of the first end and second initial pressure data of the second end; and an absolute value of a difference between the first initial pressure data and the second initial pressure data is calculated to obtain a second difference.

Optionally, the electric motor is controlled to rotate in the predetermined direction at the predetermined speed at least according to the first difference, so that the electric skateboard advances or retreats includes: a speed of the electric skateboard at a current moment is acquired in real time; an absolute value of a difference between the first difference and the second difference is calculated to obtain a third difference; the electric motor is controlled not to rotate in a case that the third difference is within a predetermined range, and the electric skateboard is controlled not to move or to decelerate until the electric skateboard stops according to the speed; and the electric motor is controlled to rotate in the predetermined direction at the predetermined speed at least according to the first pressure data and the second pressure data in a case that the third difference is out of the predetermined range, so that the electric skateboard advances or retreats.

Optionally, a direction in which the second end points at the first end is a first direction, and a direction in which the first end points at the second end is a second direction; and the electric motor is controlled to rotate in the predetermined direction at the predetermined speed at least according to the first pressure data and the second pressure data, so that the electric skateboard advances or retreats includes: the electric motor is controlled to rotate forward in a case that the first pressure data are greater than the second pressure data and a direction of the speed is the first direction, so that the electric skateboard moves in the first direction, and the predetermined speed is determined according to the first difference; the electric motor is controlled to rotate reversely in a case that the second pressure data are greater than the first pressure data and the direction of the speed is the second direction, so that the electric skateboard moves in the second direction, and the predetermined speed is determined according to the first difference; the electric motor is controlled to rotate forward in a case that the first pressure data are greater than the second pressure data and the direction of the speed is the second direction, so that the electric skateboard decelerates in the second direction; and the electric motor is controlled to rotate reversely in a case that the second pressure data are greater than the first pressure data and the direction of the speed is the first direction, so that the electric skateboard decelerates in the first direction.

Optionally, the electric motor is controlled to rotate forward in the case that the first pressure data are greater than the second pressure data and the direction of the speed is the first direction, so that the electric skateboard moves in the first direction, and the predetermined speed is determined according to the first difference include: the electric motor is controlled to rotate forward and the predetermined speed of the electric motor is increased in a case that a change rate of the first difference is a positive number, so that the electric skateboard accelerates in the first direction; and the electric motor is controlled to rotate forward and the predetermined speed of the electric motor is decreased in a case that the change rate of the first difference is a negative number, so that the electric skateboard decelerates in the first direction.

Optionally, the electric motor is controlled to rotate reversely in the case that the second pressure data are greater than the first pressure data and the direction of the speed is the second direction, so that the electric skateboard moves in the second direction, and the predetermined speed is determined according to the first difference include: the electric motor is controlled to rotate reversely and the predetermined speed of the electric motor is increased in a case that a change rate of the first difference is a positive number, so that the electric skateboard accelerates in the second direction; and the electric motor is controlled to rotate reversely and the predetermined speed of the electric motor is decreased in a case that the change rate of the first difference is a negative number, so that the electric skateboard decelerates in the second direction.

In another aspect, an apparatus for controlling an electric skateboard is further provided in an example of the disclosure. The electric skateboard includes an electric motor and two strain sensors, and the two strain sensors are arranged at two ends of the electric skateboard respectively; and the apparatus includes: a first acquisition component, a first calculation component, and a control component; and the first acquisition component is configured to acquire pressure data of the two strain sensors in real time, and the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard; the first calculation component is configured to calculate an absolute value of a difference between the first pressure data and the second pressure data to obtain a first difference; and the control component is configured to control the electric motor to rotate in a predetermined direction at a predetermined speed at least according to the first difference, so that the electric skateboard advances or retreats, and the predetermined direction indicates forward rotation or reverse rotation.

In yet another aspect, a non-transitory computer-readable storage medium is further provided in an example of the disclosure. The non-transitory computer-readable storage medium includes a program stored, and the program is configured to execute any method described above.

In yet another aspect, a processor is further provided in an example of the disclosure. The processor is configured to run a program, and the program executes any method described above when run.

In still another aspect, an electric skateboard is further provided in an example of the disclosure. The electric skateboard includes two strain sensors, an electric motor, and a controller; and the two strain sensors are arranged at two ends of the electric skateboard respectively, the strain sensors are configured to sense pressure data, and the pressure data are pressure data generated in a case that a target object stands on the electric skateboard; the electric motor is configured to control the electric skateboard to move; and the controller is configured to execute any method described above.

### BRIEF DESCRIPTION OF THE DRAWINGS

The drawings of the description are used to provide further understanding of the disclosure as a constituent part of the disclosure. Illustrative examples of the disclosure and their descriptions serve to explain the disclosure, instead of limiting the disclosure improperly. In the accompanying drawings:

FIG. 1 is a schematic flowchart of a method for controlling an electric skateboard according to an example of the disclosure;

FIG. 2 is a schematic diagram of an apparatus for controlling an electric skateboard according to an example of the disclosure; and

FIG. 3 is a schematic diagram of an electric skateboard according to an example of the disclosure.

The above accompanying drawings include the reference numerals as follows:

40. strain sensor; 50. board surface; and 60. bridge frame.

### DETAILED DESCRIPTION OF THE EMBODIMENTS

It should be noted that examples of the disclosure and features in the examples can be mutually combined without conflicts. The disclosure will be described in detail below in conjunction with the accompanying drawings and the examples.

In order to enable those skilled in the art to better understand solutions of the disclosure, the technical solutions in the examples of the disclosure will be clearly and comprehensively described below in conjunction with the accompanying drawings in the examples of the disclosure. Apparently, the examples described are merely some examples rather than all examples of the disclosure. Based on the examples of the disclosure, all other examples derived by those of ordinary skill in the art without creative efforts should fall within the scope of protection of the disclosure.

It should be noted that the terms “first”, “second”, etc. in the description, the claims, and the above accompanying drawings of the disclosure are used to distinguish between similar objects, instead of necessarily describing a specific sequence or a successive order. It should be understood that data used in this way can be interchanged where appropriate, so as to facilitate the examples described herein of the disclosure. In addition, the terms “include”, “have”, and their any variations are intended to cover non-exclusive inclusions. For example, processes, methods, systems, products, or devices encompassing a series of steps or components can include other steps or components that are not explicitly listed or are inherent to these processes, methods, products, or devices, without being limited to those steps or components explicitly listed.

It should be understood that when an element, such as a layer, film, region, or substrate, is described as being “on” another element, the element can be directly on another element or intervening elements can also be present. Moreover, in the description and the claims, when an element is described as being “connected” to another element, the element can be “directly connected” to another element or “connected” to another element through a third element.

As mentioned in the background art that a target user has undesirable use experience due to a complex control process of an electric skateboard in the prior art, a method and apparatus for controlling an electric skateboard, a non-transitory computer-readable storage medium, a processor, and an electric skateboard are provided in a typical embodiment of the disclosure, in order to solve the above problem.

A method for controlling an electric skateboard is provided in an example of the disclosure. The electric skateboard includes an electric motor and two strain sensors, and the two strain sensors are arranged at two ends of the electric skateboard respectively.

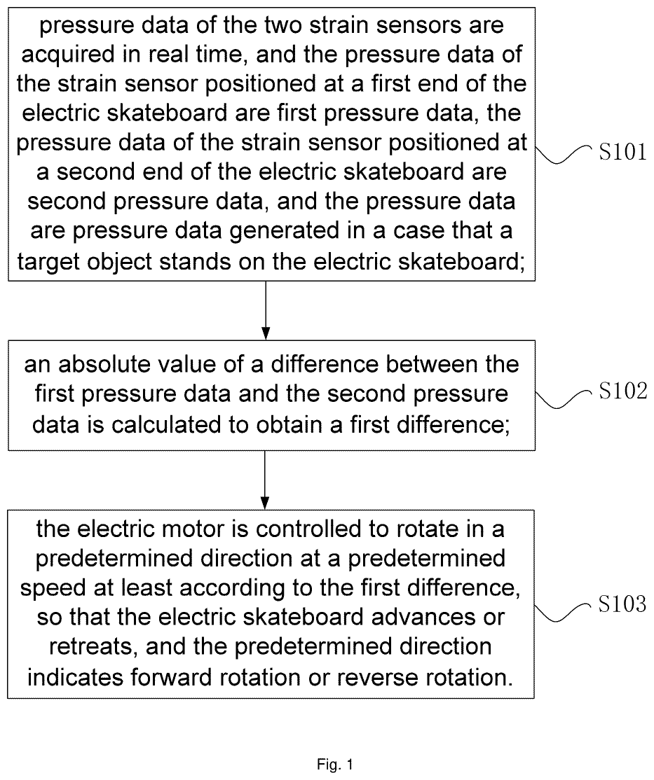

FIG. 1 is a flowchart of a method for controlling an electric skateboard according to an example of the disclosure. As shown in FIG. 1, the method includes:
S101, pressure data of the two strain sensors are acquired in real time, and the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard;
S102, an absolute value of a difference between the first pressure data and the second pressure data is calculated to obtain a first difference; and
S103, the electric motor is controlled to rotate in a predetermined direction at a predetermined speed at least according to the first difference, so that the electric skateboard advances or retreats, and the predetermined direction indicates forward rotation or reverse rotation.

In the method for controlling the electric skateboard, firstly, the pressure data of the two strain sensors are acquired in real time, and the pressure data of the strain sensor positioned at the first end of the electric skateboard are the first pressure data, the pressure data of the strain sensor positioned at the second end of the electric skateboard are the second pressure data, and the pressure data are the pressure data generated in the case that the target object stands on the electric skateboard; then, the absolute value of the difference between the first pressure data and the second pressure data is calculated to obtain the first difference; and finally, the electric motor is controlled to rotate in the predetermined direction at the predetermined speed at least according to the first difference, so that the electric skateboard advances or retreats, and the predetermined direction indicates the forward rotation or the reverse rotation. Compared with the prior art that a target user has undesirable use experience due to a complex control process of an electric skateboard, in the method for controlling the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.

In a specific example, the strain pressure sensors are positioned between a board surface and a bridge frame of the electric skateboard. The bridge frame ensures that the electric skateboard may be controlled to turn left or right according to left tilt or right tilt (also called forward tilt or backward tilt) of the target user. It is further ensured that the electric skateboard may change the speed and the direction according to the intention of the target user.

In order to further ensure the desirable experience of the target user, according to a specific example of the disclosure, before the pressure data of the two strain sensors are acquired in real time, the method further includes: initial pressure data of the two strain sensors are acquired, and the initial pressure data are the pressure data generated when the target object stands on the electric skateboard with two feet, and the initial pressure data include first initial pressure data of the first end and second initial pressure data of the second end; and an absolute value of a difference between the first initial pressure data and the second initial pressure data is calculated to obtain a second difference. The initial pressure data of the target user are acquired and the second difference is calculated, so that the pressure data of the target user generated when the electric skateboard is in a stationary state may be acquired. Accordingly, the predetermined direction and the predetermined speed of the electric motor may be controlled more accurately according to the second difference in a later stage. It is further ensured that the direction and the movement speed of the electric skateboard may be controlled completely through the somatosensation of the target user, so that the target user has the desirable experience.

Specifically, the initial pressure data are pressure data generated when the target user keeps the legs standing upright and standing firmly on the board surface of the electric skateboard for a short time before the electric skateboard is used each time. In this case, the electric motor does not rotate, and the electric skateboard keeps a stationary state that is calibrated as an initial state.

According to another specific example of the disclosure, the electric motor is controlled to rotate in the predetermined direction at the predetermined speed at least according to the first difference, so that the electric skateboard advances or retreats includes: a speed of the electric skateboard at a current moment is acquired in real time; an absolute value of a difference between the first difference and the second difference is calculated to obtain a third difference; the electric motor is controlled not to rotate in a case that the third difference is within a predetermined range, and the electric skateboard is controlled not to move or to decelerate until the electric skateboard stops according to the speed; and the electric motor is controlled to rotate in the predetermined direction at the predetermined speed at least according to the first pressure data and the second pressure data in a case that the third difference is out of the predetermined range, so that the electric skateboard advances or retreats. The third difference is obtained and the electric motor is controlled not to rotate in the case that the third difference is within the predetermined range. Therefore, it is ensured that the electric motor is controlled not to rotate in a case that the target user does not intend to control the electric skateboard to move, so that the electric skateboard decelerates to a stop or remains stationary. The electric motor is controlled to rotate in the predetermined direction at the predetermined speed according to the first pressure data and the second pressure data in the case that the third difference is out of the predetermined range, so that the electric skateboard advances or retreats. Therefore, it is further ensured that the direction and the movement speed of the electric skateboard may be controlled completely according to the intention of the target user, so that the target user has the desirable experience.

Specifically, the electric motor is controlled not to rotate in the case that the third difference is within the predetermined range. The electric skateboard starts to decelerate in a case that the speed of the electric skateboard is high. The electric skateboard remains stationary in a case that the speed of the electric skateboard is zero.

According to yet another specific example of the disclosure, a direction in which the second end points at the first end is a first direction, and a direction in which the first end points at the second end is a second direction; and the step that the electric motor is controlled to rotate in the predetermined direction at the predetermined speed at least according to the first pressure data and the second pressure data, so that the electric skateboard advances or retreats includes: the electric motor is controlled to rotate forward in a case that the first pressure data are greater than the second pressure data and a direction of the speed is the first direction, so that the electric skateboard moves in the first direction, and the predetermined speed is determined according to the first difference; the electric motor is controlled to rotate reversely in a case that the second pressure data are greater than the first pressure data and the direction of the speed is the second direction, so that the electric skateboard moves in the second direction, and the predetermined speed is determined according to the first difference; the electric motor is controlled to rotate forward in a case that the first pressure data are greater than the second pressure data and the direction of the speed is the second direction, so that the electric skateboard decelerates in the second direction; and the electric motor is controlled to rotate reversely in a case that the second pressure data are greater than the first pressure data and the direction of the speed is the first direction, so that the electric skateboard decelerates in the first direction. The electric motor is controlled to rotate forward in the case that the first pressure data are greater than the second pressure data; and the electric skateboard moves in the first direction at a movement speed related to the first difference in the case that the direction of the speed is the first direction, and the electric skateboard decelerates in the second direction in the case that the direction of the speed is the second direction. The electric motor is controlled to rotate reversely in the case that the second pressure data are greater than the first pressure data, and the electric skateboard moves in the second direction at a movement speed related to the first difference in the case that the direction of the speed is the second direction, and the electric skateboard decelerates in the first direction in the case that the direction of the speed is the first direction, which ensure that the user may accurately control the movement direction and the speed of the electric skateboard according to the pressure data. It is further ensured that the direction and the movement speed of the electric skateboard may be controlled completely according to the intention of the target user, so that the target user has the desirable experience.

Specifically, when the target user leans from a initial state towards the first end of the electric skateboard, the first pressure data are gradually increased, and moreover, the second pressure data are gradually decreased, the electric motor is activated and starts to rotate forward, and the electric skateboard starts to move in the first direction, and the greater the third difference is, the higher the predetermined speed of the electric motor is, and the higher the speed of the electric skateboard is. Similarly, when the target user starts to lean towards the second end of the electric skateboard, the second pressure data are gradually increased, and moreover, the first pressure data are gradually decreased, the electric motor is activated and starts to rotate reversely, so that the electric skateboard moves in the second direction, and the greater the third difference is, the higher the predetermined speed of the electric motor is, and the higher the speed of the electric skateboard is. Similarly, if the target user leans from the first end or the second end of the electric skateboard towards the initial state, the predetermined speed of the electric motor starts to decrease, so that the electric skateboard starts to decelerate until the electric skateboard stops.

In order to further ensure the desirable experience of the target user, according to a specific example of the disclosure, the electric motor is controlled to rotate forward in the case that the first pressure data are greater than the second pressure data and the direction of the speed is the first direction, so that the electric skateboard moves in the first direction, and the predetermined speed is determined according to the first difference include: the electric motor is controlled to rotate forward and the predetermined speed of the electric motor is increased in a case that a change rate of the first difference is a positive number, so that the electric skateboard accelerates in the first direction; and the electric motor is controlled to rotate forward and the predetermined speed of the electric motor is decreased in a case that the change rate of the first difference is a negative number, so that the electric skateboard decelerates in the first direction. The electric motor is controlled to rotate forward in the case that the first pressure data are greater than the second pressure data and the speed direction of the electric skateboard is the first direction, the electric skateboard accelerates in the first direction in the case that the change rate of the first difference is the positive number, and the electric skateboard decelerates in the first direction in the case that the change rate of the first difference is the negative number, which ensure that the user may control the speed of the electric skateboard after leaning to the front or back. It is further ensured that the direction and the movement speed of the electric skateboard may be controlled completely according to the intention of the target user, so that the target user has the desirable experience.

In order to further ensure the desirable experience of the target user, according to another example of the disclosure, the electric motor is controlled to rotate reversely in the case that the second pressure data are greater than the first pressure data and the direction of the speed is the second direction, so that the electric skateboard moves in the second direction, and the predetermined speed is determined according to the first difference include: the electric motor is controlled to rotate reversely and the predetermined speed of the electric motor is increased in a case that a change rate of the first difference is a positive number, so that the electric skateboard accelerates in the second direction; and the electric motor is controlled to rotate reversely and the predetermined speed of the electric motor is decreased in a case that the change rate of the first difference is a negative number, so that the electric skateboard decelerates in the second direction. The electric motor is controlled to rotate reversely in the case that the second pressure data are greater than the first pressure data and the speed direction of the electric skateboard is the second direction, the electric skateboard accelerates in the second direction in the case that the change rate of the first difference is the positive number, and the electric skateboard decelerates in the second direction in the case that the change rate of the first difference is the negative number, which ensure that the user may control the speed of the electric skateboard after leaning to the front or back. It is further ensured that the direction and the movement speed of the electric skateboard may be controlled completely according to the intention of the target user, so that the target user has the desirable experience.

An apparatus for controlling an electric skateboard is further provided in an example of the disclosure. The electric skateboard includes an electric motor and two strain sensors, and the two strain sensors are arranged at two ends of the electric skateboard respectively. It should be noted that the apparatus for controlling the electric skateboard in the example of the disclosure may be configured to execute the method for controlling the electric skateboard according to the example of the disclosure. The apparatus for controlling an electric skateboard according to the example of the disclosure is described below.

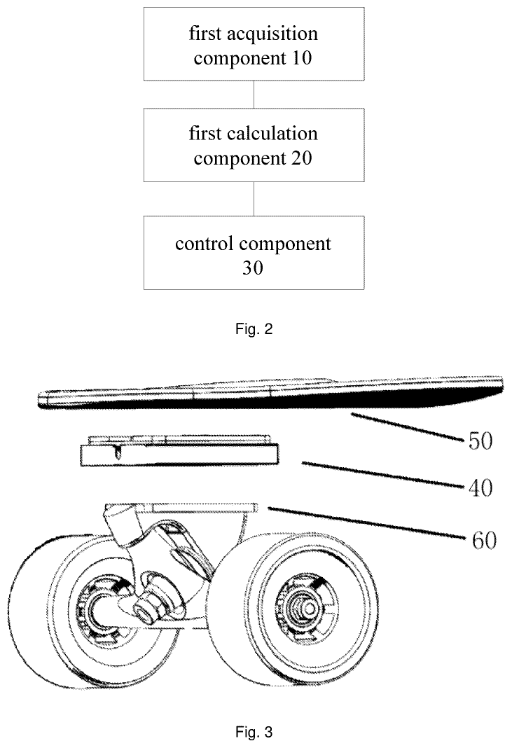

FIG. 2 is a schematic diagram of an apparatus for controlling an electric skateboard according to the example of the disclosure. As shown in FIG. 2, the apparatus includes a first acquisition component 10, a first calculation component 20, and a control component 30, and the first acquisition component 10 is configured to acquire pressure data of the two strain sensors in real time, and the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard; the first calculation component 20 is configured to calculate an absolute value of a difference between the first pressure data and the second pressure data to obtain a first difference; and the control component 30 is configured to control the electric motor to rotate in a predetermined direction at a predetermined speed at least according to the first difference, so that the electric skateboard advances or retreats, where the predetermined direction indicates forward rotation or reverse rotation.

In the apparatus for controlling the electric skateboard, the first acquisition component is configured to acquire the pressure data of the two strain sensors in real time, and the pressure data of the strain sensor positioned at the first end of the electric skateboard are the first pressure data, the pressure data of the strain sensor positioned at the second end of the electric skateboard are the second pressure data, and the pressure data are the pressure data generated in the case that the target object stands on the electric skateboard; the first calculation component is configured to calculate the absolute value of the difference between the first pressure data and the second pressure data to obtain the first difference; and the control component is configured to control the electric motor to rotate in the predetermined direction at the predetermined speed at least according to the first difference, so that the electric skateboard advances or retreats, and the predetermined direction indicates the forward rotation or the reverse rotation. Compared with the prior art that a target user has undesirable use experience due to a complex control process of an electric skateboard, in the apparatus for controlling the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.

In a specific example, the strain pressure sensors are positioned between a board surface and a bridge frame of the electric skateboard. The bridge frame ensures that the electric skateboard may be controlled to turn left or right according to left tilt or right tilt (also called forward tilt or backward tilt) of the target user. It is further ensured that the electric skateboard may change the speed and the direction according to the intention of the target user.

In order to further ensure the desirable experience of the target user, according to a specific example of the disclosure, the apparatus further includes a second acquisition component and a second calculation component. The second acquisition component is configured to acquire initial pressure data of the two strain sensors before acquiring the pressure data of the two strain sensors in real time, and the initial pressure data are the pressure data generated when the target object stands on the electric skateboard with two feet, and the initial pressure data include first initial pressure data of the first end and second initial pressure data of the second end. The second calculation component is configured to calculate an absolute value of a difference between the first initial pressure data and the second initial pressure data to obtain a second difference. The initial pressure data of the target user are acquired and the second difference is calculated, so that the pressure data of the target user generated when the electric skateboard is in a stationary state may be acquired. Accordingly, the predetermined direction and the predetermined speed of the electric motor may be controlled more accurately according to the second difference in a later stage. It is further ensured that the direction and the movement speed of the electric skateboard may be controlled completely through the somatosensation of the target user, so that the target user has the desirable experience.

Specifically, the initial pressure data are pressure data generated when the target user keeps the legs standing upright and standing firmly on the board surface of the electric skateboard for a short time before the electric skateboard is used each time. In this case, the electric motor does not rotate, and the electric skateboard keeps a stationary state that is calibrated as an initial state.

According to another specific example of the disclosure, the control component includes an acquisition module, a calculation module, a first control module, and a second control module. The acquisition module is configured to acquire a speed of the electric skateboard at a current moment in real time. The calculation module is configured to calculate an absolute value of a difference between the first difference and the second difference to obtain a third difference. The first control module is configured to control the electric motor not to rotate in a case that the third difference is within a predetermined range, and control the electric skateboard not to move or to decelerate until the electric skateboard stops according to the speed. The second control module is configured to control the electric motor to rotate in the predetermined direction at the predetermined speed at least according to the first pressure data and the second pressure data in a case that the third difference is out of the predetermined range, so that the electric skateboard advances or retreats. The third difference is obtained and the electric motor is controlled not to rotate in the case that the third difference is within the predetermined range. Therefore, it is ensured that the electric motor is controlled not to rotate in a case that the target user does not intend to control the electric skateboard to move, so that the electric skateboard decelerates to a stop or remains stationary. The electric motor is controlled to rotate in the predetermined direction at the predetermined speed according to the first pressure data and the second pressure data in the case that the third difference is out of the predetermined range, so that the electric skateboard advances or retreats. Therefore, it is further ensured that the direction and the movement speed of the electric skateboard may be controlled completely according to the intention of the target user, so that the target user has the desirable experience.

Specifically, the electric motor is controlled not to rotate in the case that the third difference is within the predetermined range. The electric skateboard starts to decelerate in a case that the speed of the electric skateboard is high. The electric skateboard remains stationary in a case that the speed of the electric skateboard is zero.

According to yet another specific example of the disclosure, a direction in which the second end points at the first end is a first direction, and a direction in which the first end points at the second end is a second direction. The second control module includes a first control sub-module, a second control sub-module, a third control sub-module, and a fourth control sub-module. The first control sub-module is configured to control the electric motor to rotate forward in a case that the first pressure data are greater than the second pressure data and a direction of the speed is the first direction, so that the electric skateboard moves in the first direction, and determine the predetermined speed according to the first difference. The second control sub-module is configured to control the electric motor to rotate reversely in a case that the second pressure data are greater than the first pressure data and the direction of the speed is the second direction, so that the electric skateboard moves in the second direction, and determine the predetermined speed according to the first difference. The third control sub-module is configured to control the electric motor to rotate forward in a case that the first pressure data are greater than the second pressure data and the direction of the speed is the second direction, so that the electric skateboard decelerates in the second direction. The fourth control sub-module is configured to control the electric motor to rotate reversely in a case that the second pressure data are greater than the first pressure data and the direction of the speed is the first direction, so that the electric skateboard decelerates in the first direction.

Specifically, when the target user leans from a initial state towards the first end of the electric skateboard, the first pressure data are gradually increased, and moreover, the second pressure data are gradually decreased, the electric motor is activated and starts to rotate forward, and the electric skateboard starts to move in the first direction and the greater the third difference is, the higher the predetermined speed of the electric motor is, and the higher the speed of the electric skateboard is. Similarly, when the target user starts to lean towards the second end of the electric skateboard, the second pressure data are gradually increased, and moreover, the first pressure data are gradually decreased, the electric motor is activated and starts to rotate reversely, so that the electric skateboard moves in the second direction, and the greater the third difference is, the higher the predetermined speed of the electric motor is, and the higher the speed of the electric skateboard is. Similarly, if the target user leans from the first end or the second end of the electric skateboard towards the initial state, the predetermined speed of the electric motor starts to decrease, so that the electric skateboard starts to decelerate until the electric skateboard stops.

In order to further ensure the desirable experience of the target user, according to a specific example of the disclosure, the first control sub-module is further configured to control the electric motor to rotate forward and increase the predetermined speed of the electric motor in a case that a change rate of the first difference is a positive number, so that the electric skateboard accelerates in the first direction; and control the electric motor to rotate forward and decrease the predetermined speed of the electric motor in a case that a change rate of the first difference is a negative number, so that the electric skateboard decelerates in the first direction. The electric motor is controlled to rotate forward in the case that the first pressure data are greater than the second pressure data and the speed direction of the electric skateboard is the first direction, the electric skateboard accelerates in the first direction in the case that the change rate of the first difference is the positive number, and the electric skateboard decelerates in the first direction in the case that the change rate of the first difference is the negative number, which ensure that the user may control the speed of the electric skateboard after leaning to the front or back. It is further ensured that the direction and the movement speed of the electric skateboard may be controlled completely according to the intention of the target user, so that the target user has the desirable experience.

In order to further ensure the desirable experience of the target user, according to another specific example of the disclosure, the second control sub-module is further configured to control the electric motor to rotate reversely and increase the predetermined speed of the electric motor in a case that a change rate of the first difference is a positive number, so that the electric skateboard accelerates in the second direction; and control the electric motor to rotate reversely and decrease the predetermined speed of the electric motor in a case that a change rate of the first difference is a negative number, so that the electric skateboard decelerates in the second direction. The electric motor is controlled to rotate reversely in the case that the second pressure data are greater than the first pressure data and the speed direction of the electric skateboard is the second direction, the electric skateboard accelerates in the second direction in the case that the change rate of the first difference is the positive number, and the electric skateboard decelerates in the second direction in the case that the change rate of the first difference is the negative number, which ensure that the user may control the speed of the electric skateboard after leaning to the front or back. It is further ensured that the direction and the movement speed of the electric skateboard may be controlled completely according to the intention of the target user, so that the target user has the desirable experience.

The apparatus for controlling an electric skateboard includes a processor and a memory. The first acquisition component, the first determination component, the control component, etc. are stored in the memory as program components, and the processor executes the program components stored in the memory to implement corresponding functions.

The processor includes a kernel, which retrieves the corresponding program component from the memory. One or more kernels may be configured. Accordingly, the problem that the target user has the undesirable use experience due to the complex control process of the electric skateboard in the prior art is solved by adjusting kernel parameters.

The memory may include a non-permanent memory, such as a random access memory (RAM) and/or a non-volatile memory, such as a read-only memory (ROM) or a flash RAM in a computer-readable medium. The memory includes at least one memory chip.

A non-transitory computer-readable storage medium is further provided in an example of the disclosure. The non-transitory computer-readable storage medium stores a program, where the program implements the method for controlling an electric skateboard when executed by a processor.

A processor is provided in an example of the disclosure. The processor is configured to run a program, where the program executes the method for controlling an electric skateboard when run.

A device is provided in an example of the disclosure. The device includes a processor, a memory, and a program stored on the memory and runnable by the processor, where when executing the program, the processor implements at least the following:
S101, pressure data of two strain sensors are acquired in real time, and the pressure data of the strain sensor positioned at a first end of an electric skateboard are first pressure data, the pressure data of the strain sensor positioned at a second end of the electric skateboard are second pressure data, and the pressure data are pressure data generated in a case that a target object stands on the electric skateboard;
S102, an absolute value of a difference between the first pressure data and the second pressure data is calculated to obtain a first difference; and
S103, an electric motor is controlled to rotate in a predetermined direction at a predetermined speed at least according to the first difference, so that the electric skateboard advances or retreats, and the predetermined direction indicates forward rotation or reverse rotation.

The device herein may be a server, a personal computer (PC), a portable Android device (PAD), a mobile phone, etc.

A computer program product is further provided in the disclosure. When executed on a data processing device, the computer program product is suitable for executing a program initialized with at least method steps as follows:
S101, pressure data of two strain sensors are acquired in real time, and the pressure data of the strain sensor positioned at a first end of an electric skateboard are first pressure data, the pressure data of the strain sensor positioned at a second end of the electric skateboard are second pressure data, and the pressure data are pressure data generated in a case that a target object stands on the electric skateboard;
S102, an absolute value of a difference between the first pressure data and the second pressure data is calculated to obtain a first difference; and
S103, an electric motor is controlled to rotate in a predetermined direction at a predetermined speed at least according to the first difference, so that the electric skateboard advances or retreats, and the predetermined direction indicates forward rotation or reverse rotation.

An electric skateboard is further provided in another typical example of the disclosure. The electric skateboard includes two strain sensors, an electric motor, and a controller, and the two strain sensors are arranged at two ends of the electric skateboard respectively, the strain sensors are configured to sense pressure data, and the pressure data are pressure data generated in a case that a target object stands on the electric skateboard; the electric motor is configured to control the electric skateboard to move; and the controller is configured to execute any method described above.

The electric skateboard includes the two strain sensors, the electric motor, and the controller; and the two strain sensors are arranged at the two ends of the electric skateboard respectively, the strain sensors are configured to sense pressure data, and the pressure data are the pressure data generated in the case that the target object stands on the electric skateboard; the electric motor is configured to control the electric skateboard to move; and the controller is configured to execute any method described above. Compared with the prior art that a target user has undesirable use experience due to a complex control process of an electric skateboard, in the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.

Specifically, as shown in FIG. 3, the strain sensor 40 is positioned between the board surface 50 and the bridge frame 60, and the target user stands on the board surface 50 to control a left-right direction through the bridge frame 60.

The description in each example of the disclosure has its own emphasis. Reference may be made to the relevant descriptions of other examples for the part not described in detail in a certain example.

In several examples provided by the disclosure, it should be understood that the technical contents disclosed may be implemented in other ways. The apparatus example described above is merely illustrative. For example, the components are divided merely by logic function. Other division methods may be employed during practical implementation. For example, a plurality of components or components may be combined or integrated into another system. Alternatively, some features may be omitted or may not be executed. Further, mutual coupling, direct coupling, or communication connection shown or discussed may be indirect coupling or communication connection through some interfaces, components, or modules in an electrical manner, etc.

The component described as a separate component may be physically separated or not. The component shown as a component may be a physical component or not. That is, the components may be positioned in one place or distributed over a plurality of components. Some or all components may be selected as required actually to implement the solution in the example.

Further, all function components in each example of the disclosure may be integrated into one processing component. Each component may also be physically present alone. Two or more components may also be integrated into one component. The above integrated components may be implemented in the form of hardware or software function components.

If being implemented in the form of software function components and sold or used as independent products, the integrated components may be stored in one non-transitory computer-readable storage medium. Based on such understanding, the technical solutions of the disclosure in essence, the part that contributes to the prior art, or all or some of the technical solutions may be embodied in the form of a software product. The computer software product is stored in one storage medium and includes several instructions configured to enable a computer device (which may be a personal computer, a server, or a network device) to execute all or some of the steps of the method in each example of the disclosure. The foregoing storage medium includes: various media capable of storing a program code, such as a universal serial bus (USB) flash disk, a read-only memory (ROM), a random access memory (RAM), a mobile hard disk, a magnetic disk, and an optical disk.

It can be seen from the above description that the examples of the disclosure implement the technical effects as follows:
1) In the method for controlling the electric skateboard, firstly, the pressure data of the two strain sensors are acquired in real time, and the pressure data of the strain sensor positioned at the first end of the electric skateboard are the first pressure data, the pressure data of the strain sensor positioned at the second end of the electric skateboard are the second pressure data, and the pressure data are the pressure data generated in the case that the target object stands on the electric skateboard; then, the absolute value of the difference between the first pressure data and the second pressure data is calculated to obtain the first difference; and finally, the electric motor is controlled to rotate in the predetermined direction at the predetermined speed at least according to the first difference, so that the electric skateboard advances or retreats, and the predetermined direction indicates the forward rotation or the reverse rotation. Compared with the prior art that a target user has undesirable use experience due to a complex control process of an electric skateboard, in the method for controlling the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.
2) In the apparatus for controlling the electric skateboard, the first acquisition component is configured to acquire the pressure data of the two strain sensors in real time, and the pressure data of the strain sensor positioned at the first end of the electric skateboard are the first pressure data, the pressure data of the strain sensor positioned at the second end of the electric skateboard are the second pressure data, and the pressure data are the pressure data generated in the case that the target object stands on the electric skateboard; the first calculation component is configured to calculate the absolute value of the difference between the first pressure data and the second pressure data to obtain the first difference; and the control component is configured to control the electric motor to rotate in the predetermined direction at the predetermined speed at least according to the first difference, so that the electric skateboard advances or retreats, and the predetermined direction indicates the forward rotation or the reverse rotation. Compared with the prior art that a target user has undesirable use experience due to a complex control process of an electric skateboard, in the apparatus for controlling the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.
3) The electric skateboard includes the two strain sensors, the electric motor, and the controller; and the two strain sensors are arranged at the two ends of the electric skateboard respectively, the strain sensors are configured to sense pressure data, and the pressure data are the pressure data generated in the case that the target object stands on the electric skateboard; the electric motor is configured to control the electric skateboard to move; and the controller is configured to execute any method described above. Compared with the prior art that a target user has undesirable use experience due to a complex control process of an electric skateboard, in the electric skateboard of the disclosure, one strain sensor is arranged at each end of the electric skateboard, the absolute value of the difference between the first pressure data and the second pressure data at the two ends of the electric skateboard respectively is calculated, and the electric motor is controlled to rotate in the predetermined direction at the predetermined speed according to the absolute value of the difference, so that the electric skateboard advances or retreats. Moreover, with a speed of the electric skateboard controlled, the electric skateboard is controlled to advance or retreat only through the two strain sensors, and a movement speed of the electric skateboard is controlled, so that the direction and the movement speed of the electric skateboard may be controlled completely through the somatosensation of the target user. Accordingly, the target user has desirable use experience, and the problem that the target user has the undesirable use experience due to the complex control process of the electric skateboard in the prior art is solved.

What are described above are merely preferred examples of the disclosure and are not intended to limit the disclosure. Those skilled in the art can make various modifications and variations to the disclosure. Any modifications, equivalent replacements, improvements, etc. made within the spirit and principles of the disclosure should fall within the scope of protection of the disclosure.

1. A method for controlling an electric skateboard, wherein the electric skateboard comprises an electric motor and two strain sensors, and the two strain sensors are arranged at two ends of the electric skateboard respectively; and the method comprises:
acquiring pressure data of the two strain sensors in real time, wherein the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard;
calculating an absolute value of a difference between the first pressure data and the second pressure data to obtain a first difference; and
controlling the electric motor to rotate in a predetermined direction at a predetermined speed at least according to the first difference, so that the electric skateboard advances or retreats, wherein the predetermined direction indicates forward rotation or reverse rotation.

2. The method as claimed in claim 1, wherein before acquiring the pressure data of the two strain sensors in real time, the method further comprises:
acquiring initial pressure data of the two strain sensors, wherein the initial pressure data are the pressure data generated when the target object stands on the electric skateboard with two feet, and the initial pressure data comprise first initial pressure data of the first end and second initial pressure data of the second end; and
calculating an absolute value of a difference between the first initial pressure data and the second initial pressure data to obtain a second difference.

3. The method as claimed in claim 2, wherein controlling the electric motor to rotate in the predetermined direction at the predetermined speed at least according to the first difference, so that the electric skateboard advances or retreats comprises:
acquiring a speed of the electric skateboard at a current moment in real time;
calculating an absolute value of a difference between the first difference and the second difference to obtain a third difference;
controlling the electric motor not to rotate in a case that the third difference is within a predetermined range, and controlling the electric skateboard not to move or to decelerate until the electric skateboard stops according to the speed; and
controlling the electric motor to rotate in the predetermined direction at the predetermined speed at least according to the first pressure data and the second pressure data in a case that the third difference is out of the predetermined range, so that the electric skateboard advances or retreats.

4. The method as claimed in claim 3, wherein a direction in which the second end points at the first end is a first direction, and a direction in which the first end points at the second end is a second direction; and controlling the electric motor to rotate in the predetermined direction at the predetermined speed at least according to the first pressure data and the second pressure data, so that the electric skateboard advances or retreats comprises:
controlling the electric motor to rotate forward in a case that the first pressure data are greater than the second pressure data and a direction of the speed is the first direction, so that the electric skateboard moves in the first direction, and determining the predetermined speed according to the first difference;
controlling the electric motor to rotate reversely in a case that the second pressure data are greater than the first pressure data and the direction of the speed is the second direction, so that the electric skateboard moves in the second direction, and determining the predetermined speed according to the first difference;
controlling the electric motor to rotate forward in a case that the first pressure data are greater than the second pressure data and the direction of the speed is the second direction, so that the electric skateboard decelerates in the second direction; and
controlling the electric motor to rotate reversely in a case that the second pressure data are greater than the first pressure data and the direction of the speed is the first direction, so that the electric skateboard decelerates in the first direction.

5. The method as claimed in claim 4, wherein controlling the electric motor to rotate forward in the case that the first pressure data are greater than the second pressure data and the direction of the speed is the first direction, so that the electric skateboard moves in the first direction, and determining the predetermined speed according to the first difference comprise:
controlling the electric motor to rotate forward and increasing the predetermined speed of the electric motor in a case that a change rate of the first difference is a positive number, so that the electric skateboard accelerates in the first direction; and
controlling the electric motor to rotate forward and decreasing the predetermined speed of the electric motor in a case that the change rate of the first difference is a negative number, so that the electric skateboard decelerates in the first direction.

6. The method as claimed in claim 4, wherein controlling the electric motor to rotate reversely in the case that the second pressure data are greater than the first pressure data and the direction of the speed is the second direction, so that the electric skateboard moves in the second direction, and determining the predetermined speed according to the first difference comprise:
controlling the electric motor to rotate reversely and increasing the predetermined speed of the electric motor in a case that a change rate of the first difference is a positive number, so that the electric skateboard accelerates in the second direction; and
controlling the electric motor to rotate reversely and decreasing the predetermined speed of the electric motor in a case that the change rate of the first difference is a negative number, so that the electric skateboard decelerates in the second direction.

7. (canceled)

8. A non-transitory computer-readable storage medium, comprising a program stored, wherein when the program is executed by at least one processor, is configured to cause the at least one processor to:
acquire pressure data of two strain sensors in real time, wherein the pressure data of the strain sensor positioned at a first end of an electric skateboard are first pressure data, the pressure data of the strain sensor positioned at a second end of the electric skateboard are second pressure data, and the pressure data are pressure data generated in a case that a target object stands on the electric skateboard;
calculate an absolute value of a difference between the first pressure data and the second pressure data to obtain a first difference; and
control an electric motor to rotate in a predetermined direction at a predetermined speed at least according to the first difference, so that the electric skateboard advances or retreats, wherein the predetermined direction indicates forward rotation or reverse rotation.

9. A processor, configured to run a program, wherein the program executes the method as claimed in claim 1 when run.

10. An electric skateboard, comprising:
two strain sensors arranged at two ends of the electric skateboard respectively, wherein the strain sensors are configured to sense pressure data, and the pressure data are pressure data generated in a case that a target object stands on the electric skateboard;
an electric motor configured to control the electric skateboard to move; and
a controller configured to:
acquire pressure data of the two strain sensors in real time, wherein the pressure data of the strain sensor positioned at a first end of the electric skateboard are first pressure data, the pressure data of the strain sensor positioned at a second end of the electric skateboard are second pressure data, and the pressure data are pressure data generated in a case that a target object stands on the electric skateboard;
calculate an absolute value of a difference between the first pressure data and the second pressure data to obtain a first difference; and
control the electric motor to rotate in a predetermined direction at a predetermined speed at least according to the first difference, so that the electric skateboard advances or retreats, wherein the predetermined direction indicates forward rotation or reverse rotation.

11. The method as claimed in claim 2, wherein the initial pressure data are the pressure data generated when the electric skateboard keeps a stationary state.

12. The non-transitory computer-readable storage medium as claimed in claim 8, wherein when the program is executed by the at least one processor, is configured to cause the at least one processor further to:
acquire initial pressure data of the two strain sensors before acquiring the pressure data of the two strain sensors in real time, wherein the initial pressure data are the pressure data generated when the target object stands on the electric skateboard with two feet, and the initial pressure data comprise first initial pressure data of the first end and second initial pressure data of the second end; and
calculate an absolute value of a difference between the first initial pressure data and the second initial pressure data to obtain a second difference.

13. The non-transitory computer-readable storage medium as claimed in claim 12, wherein controlling the electric motor to rotate in the predetermined direction at the predetermined speed at least according to the first difference, so that the electric skateboard advances or retreats comprises:
acquiring a speed of the electric skateboard at a current moment in real time;
calculating an absolute value of a difference between the first difference and the second difference to obtain a third difference;
controlling the electric motor not to rotate in a case that the third difference is within a predetermined range, and controlling the electric skateboard not to move or to decelerate until the electric skateboard stops according to the speed; and
controlling the electric motor to rotate in the predetermined direction at the predetermined speed at least according to the first pressure data and the second pressure data in a case that the third difference is out of the predetermined range, so that the electric skateboard advances or retreats.

14. The non-transitory computer-readable storage medium as claimed in claim 13, wherein a direction in which the second end points at the first end is a first direction, and a direction in which the first end points at the second end is a second direction; and controlling the electric motor to rotate in the predetermined direction at the predetermined speed at least according to the first pressure data and the second pressure data, so that the electric skateboard advances or retreats comprises:
controlling the electric motor to rotate forward in a case that the first pressure data are greater than the second pressure data and a direction of the speed is the first direction, so that the electric skateboard moves in the first direction, and determining the predetermined speed according to the first difference;
controlling the electric motor to rotate reversely in a case that the second pressure data are greater than the first pressure data and the direction of the speed is the second direction, so that the electric skateboard moves in the second direction, and determining the predetermined speed according to the first difference;
controlling the electric motor to rotate forward in a case that the first pressure data are greater than the second pressure data and the direction of the speed is the second direction, so that the electric skateboard decelerates in the second direction; and
controlling the electric motor to rotate reversely in a case that the second pressure data are greater than the first pressure data and the direction of the speed is the first direction, so that the electric skateboard decelerates in the first direction.

15. The non-transitory computer-readable storage medium as claimed in claim 14, wherein controlling the electric motor to rotate forward in the case that the first pressure data are greater than the second pressure data and the direction of the speed is the first direction, so that the electric skateboard moves in the first direction, and determining the predetermined speed according to the first difference comprise:
controlling the electric motor to rotate forward and increasing the predetermined speed of the electric motor in a case that a change rate of the first difference is a positive number, so that the electric skateboard accelerates in the first direction; and
controlling the electric motor to rotate forward and decreasing the predetermined speed of the electric motor in a case that the change rate of the first difference is a negative number, so that the electric skateboard decelerates in the first direction.

16. The electric skateboard as claimed in claim 10, wherein the controller is configured further to:
acquire initial pressure data of the two strain sensors before acquiring the pressure data of the two strain sensors in real time, wherein the initial pressure data are the pressure data generated when the target object stands on the electric skateboard with two feet, and the initial pressure data comprise first initial pressure data of the first end and second initial pressure data of the second end; and
calculate an absolute value of a difference between the first initial pressure data and the second initial pressure data to obtain a second difference.

17. The electric skateboard as claimed in claim 16, wherein controlling the electric motor to rotate in the predetermined direction at the predetermined speed at least according to the first difference, so that the electric skateboard advances or retreats comprises:
acquiring a speed of the electric skateboard at a current moment in real time;
calculating an absolute value of a difference between the first difference and the second difference to obtain a third difference;
controlling the electric motor not to rotate in a case that the third difference is within a predetermined range, and controlling the electric skateboard not to move or to decelerate until the electric skateboard stops according to the speed; and
controlling the electric motor to rotate in the predetermined direction at the predetermined speed at least according to the first pressure data and the second pressure data in a case that the third difference is out of the predetermined range, so that the electric skateboard advances or retreats.

18. The electric skateboard as claimed in claim 17, wherein a direction in which the second end points at the first end is a first direction, and a direction in which the first end points at the second end is a second direction; and controlling the electric motor to rotate in the predetermined direction at the predetermined speed at least according to the first pressure data and the second pressure data, so that the electric skateboard advances or retreats comprises:
controlling the electric motor to rotate forward in a case that the first pressure data are greater than the second pressure data and a direction of the speed is the first direction, so that the electric skateboard moves in the first direction, and determining the predetermined speed according to the first difference;
controlling the electric motor to rotate reversely in a case that the second pressure data are greater than the first pressure data and the direction of the speed is the second direction, so that the electric skateboard moves in the second direction, and determining the predetermined speed according to the first difference;
controlling the electric motor to rotate forward in a case that the first pressure data are greater than the second pressure data and the direction of the speed is the second direction, so that the electric skateboard decelerates in the second direction; and
controlling the electric motor to rotate reversely in a case that the second pressure data are greater than the first pressure data and the direction of the speed is the first direction, so that the electric skateboard decelerates in the first direction.

19. The electric skateboard as claimed in claim 18, wherein controlling the electric motor to rotate forward in the case that the first pressure data are greater than the second pressure data and the direction of the speed is the first direction, so that the electric skateboard moves in the first direction, and determining the predetermined speed according to the first difference comprise:
controlling the electric motor to rotate forward and increasing the predetermined speed of the electric motor in a case that a change rate of the first difference is a positive number, so that the electric skateboard accelerates in the first direction; and
controlling the electric motor to rotate forward and decreasing the predetermined speed of the electric motor in a case that the change rate of the first difference is a negative number, so that the electric skateboard decelerates in the first direction.

20. The electric skateboard as claimed in claim 18, wherein controlling the electric motor to rotate reversely in the case that the second pressure data are greater than the first pressure data and the direction of the speed is the second direction, so that the electric skateboard moves in the second direction, and determining the predetermined speed according to the first difference comprise:
controlling the electric motor to rotate reversely and increasing the predetermined speed of the electric motor in a case that a change rate of the first difference is a positive number, so that the electric skateboard accelerates in the second direction; and
controlling the electric motor to rotate reversely and decreasing the predetermined speed of the electric motor in a case that the change rate of the first difference is a negative number, so that the electric skateboard decelerates in the second direction.

21. The electric skateboard as claimed in claim 10, wherein the two strain sensors are positioned between a board surface and a bridge frame of the electric skateboard.
